(19) United States
(12) Patent Application Publication
(10) Pub. No.: US 2025/0361096 A1
(43) Pub. Date: Nov. 27, 2025

(54) OBJECT DETECTION SYSTEM FOR A CONVEYOR AND METHOD THEREOF

(71) Applicant: INTELLIGRATED HEADQUARTERS, LLC, Mason, OH (US)

(72) Inventors: Ravi JAIN, Charlotte, NC (US); Sudhanshu TIWARI, Charlotte, NC (US)

(21) Appl. No.: 19/210,492

(22) Filed: May 16, 2025

(30) Foreign Application Priority Data
May 24, 2024 (IN) 202411040427

(51) Int. Cl. B65G 43/08

(52) U.S. Cl. CPC B65G 43/08; B65G 2203/0233; B65G 2203/044

(57) ABSTRACT

An object detection system for a conveyor, where the object detection system comprises at least one sensing unit installed at a first side of at least one roller assembly of the conveyor. The at least one sensing unit comprises at least one emitter configured to emit one or more signals towards a surface of a roller of the at least one roller assembly. The surface of the roller reflects the one or more signals. Further, a knob coupled with the at least one emitter, rotates the at least one emitter to adjust one or more angles of the one or more signals. Thereafter, at least one reflector installed at a second side of the at least one roller assembly, configured to receive the one or more signals reflected from the surface of the roller and reflect the one or more signals towards the at least one receiver.

### CROSS-REFERENCE TO RELATED APPLICATIONS

This application claims priority pursuant to 35 U.S.C. 119(a) to Indian Patent Application number 202411040427, filed May 24, 2024, which application is incorporated herein by reference in its entirety.

### TECHNOLOGICAL FIELD

Example embodiments of the present disclosure relate generally to an object detection system, and more particularly, relates to an object detection system for a conveyor and a method thereof.

### BACKGROUND

Conveyor systems are a cornerstone of modern industrial processes, facilitating the seamless movement of goods and materials throughout manufacturing facilities, warehouses, and distribution centers. The conveyor systems comprise auxiliary devices that work in synchronization with the assembly to help move products in a desired manner, given the wide range of applications for which they are utilized. In conveyor systems involving one or more accumulation zones an efficient and controlled movement of parcels is crucial for a smooth operation of the conveyor system. To achieve this, the one or more accumulation zones are established to control and regulate movement of the parcels. Further, to monitor movement of the parcels Infrared Sensors, often referred to as Photo-Eyes are utilized. Such sensors are strategically positioned above rollers of the conveyor systems. These sensors detect the presence of parcels as they pass beneath, facilitating the coordination of parcel flow along the conveyor systems.

Such Infrared Sensors are effective for parcel detection but have limitations, particularly associated with height of the parcels they can reliably detect. The positioning of the sensors above the rollers results in a finite distance range within which the sensors can accurately identify presence and/or height of the parcels. Consequently, conveyor manufacturers have to specify a minimum allowable height for parcels within the warehouse or fulfillment center to ensure an optimal function of the conveyor systems.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a summary of some example embodiments to provide a basic understanding of some aspects of the present disclosure. This summary is not an extensive overview and is intended to neither identify key or critical elements nor delineate the scope of such elements. It will also be appreciated that the scope of the disclosure encompasses many potential embodiments in addition to those here summarized, some of which will be further described in the detailed description that is presented later.

In an example embodiment, an object detection system for a conveyor is disclosed. The object detection system comprises at least one sensing unit installed at a first side of at least one roller assembly of the conveyor. Further, the at least one sensing unit comprises at least one emitter positioned and configured to emit one or more signals towards a surface of a roller of the at least one roller assembly. Further, the surface of the roller is configured to reflect the one or more signals emitted by the at least one emitter, a knob coupled with the at least one emitter. Further, the knob is configured to rotate the at least one emitter to adjust one or more angles of the one or more signals, at least one receiver, and at least one reflector installed at a second side of the at least one roller assembly of the conveyor. Further, the at least one reflector is positioned to receive the one or more signals reflected from the surface of the roller and reflect the one or more signals towards the at least one receiver.

In some embodiments, the at least one sensing unit corresponds to a photo eye detector that is configured to emit the one or more signals over the surface of the roller and receive the one or more signals from the at least one reflector. In some embodiments, the one or more signals correspond to one or more light rays.

In some embodiments, the knob is configured to rotate the at least one emitter until the at least one receiver receives the one or more signals from the at least one reflector. In some embodiments, the knob defines a rotating axis, wherein the knob rotates on the rotating axis to facilitate adjustment of the at least one emitter.

In some embodiments, an angle between the one or more signals emitted by the at least one emitter and a normal to the surface of the roller defines a predefined incident angle. Further, the predefined incident angle ranges between 45-90 degrees. In some embodiments, an angle between the one or more signals reflected by the surface of the roller and the normal to the surface of the roller defines a predefined reflection angle. Further, the predefined reflection angle ranges between 45-90 degrees.

In some embodiments, the first side and the second side of the at least one roller assembly of the conveyor are configured to be positioned opposite to each other and proximate to opposite ends of the roller.

In some embodiments, the object detection system further comprising a lighting unit communicatively coupled with the at least one sensing unit. Further, the lighting unit is configured to operate in an on mode and in an off mode, operate in the on mode or the off mode upon receiving, by the at least one receiver, the one or more signals from the at least one reflector, and operate in the other of the on mode or the off mode once the one or more signals emitted by the at least one emitter over the surface of the roller is obstructed by one or more objects placed over the surface of the roller.

In some embodiments, the lighting unit is configured to be placed within the at least one sensing unit or is configured to be placed in proximity to the at least one sensing unit. In some embodiments, the lighting unit corresponds to a light emitting diode (LED) unit.

In another example embodiment, a method is disclosed. The method comprises steps of emitting, via at least one emitter of at least one sensing unit installed at a first side of at least one roller assembly of a conveyor, one or more signals towards a surface of a roller of the at least one roller assembly. Further, the surface of the roller is configured to reflect the one or more signals emitted by the at least one emitter. The method further comprises steps of rotating, via a knob of the at least one sensing unit, the at least one emitter to adjust one or more angles of the one or more signals. The method further comprises steps of receiving, via at least one reflector installed at a second side of the at least one roller assembly of the conveyor, the one or more signals reflected from the surface of the roller and reflecting, via the at least one reflector, the one or more signals towards the at least one receiver.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an object detection system installed with a conveyor in accordance with an example embodiment of the present disclosure;

FIG. 2 illustrates a side view of at least one sensing unit of the object detection system in accordance with an example embodiment of the present disclosure;

FIG. 3A illustrates a working scenario of the object detection system detecting absence of the one or more objects placed over the conveyor in accordance with an example embodiment of the present disclosure;

FIG. 3B illustrates a working scenario of the object detection system detecting the presence of the one or more objects placed over the conveyor in accordance with an example embodiment of the present disclosure;

FIG. 4 illustrates a graphical representation showing ON mode and OFF mode of a lighting unit in accordance with an example embodiment of the present disclosure; and,

FIG. 5 illustrates a flowchart showing a method of the object detection system in accordance with an example embodiment of the present disclosure.

### DETAILED DESCRIPTION

Some embodiments will now be described more fully hereinafter with reference to the accompanying drawings, in which some, but not all, embodiments of the present disclosure are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the present disclosure described herein such that embodiments may include fewer or more components than those shown in the figures while not departing from the scope of the present disclosure. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of an object detection system for a conveyor. Embodiments may comprise at least one sensing unit that may be installed at a first side of at least one roller assembly of the conveyor. Embodiments may comprise the at least one sensing unit comprises at least one emitter. Embodiments may be configured to emit one or more signals towards a surface of a roller of the at least one roller assembly. Embodiments may be configured to reflect the one or more signals emitted by the at least one emitter. Embodiments may comprise a knob that may be coupled with the at least one emitter. Embodiments may be configured to rotate the at least one emitter to adjust one or more angles of the one or more signals. Embodiments may comprise at least one receiver. Embodiments may comprise at least one reflector that may be installed at a second side of the at least one roller assembly of the conveyor. Embodiments may be positioned to receive the one or more signals reflected from the surface of the roller and reflect the one or more signals towards the at least one receiver.

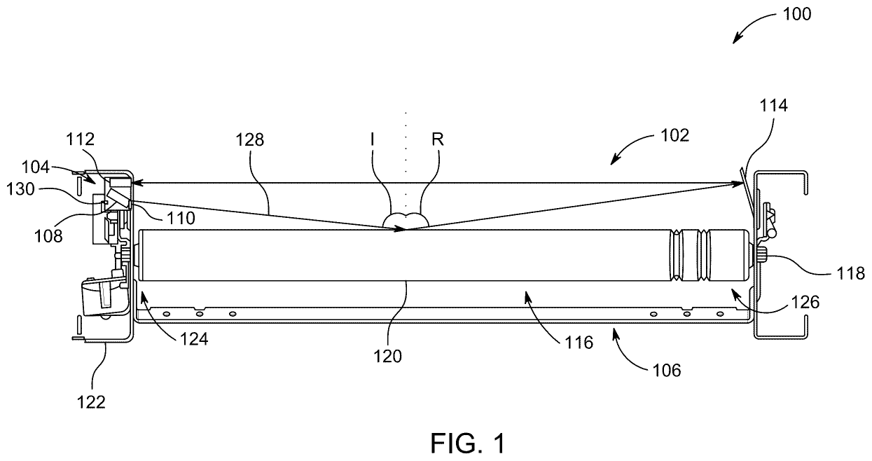

FIG. 1 illustrates an object detection system 100 installed with a conveyor 102, in accordance with an example embodiment of the present disclosure.

The object detection system 100 may comprise at least one sensing unit 104 that may be installed with at least one roller assembly 106. The at least one sensing unit 104 may comprise at least one emitter 108, a knob 110, and at least one receiver 112. Further, the object detection system 100 may comprise at least one reflector 114.

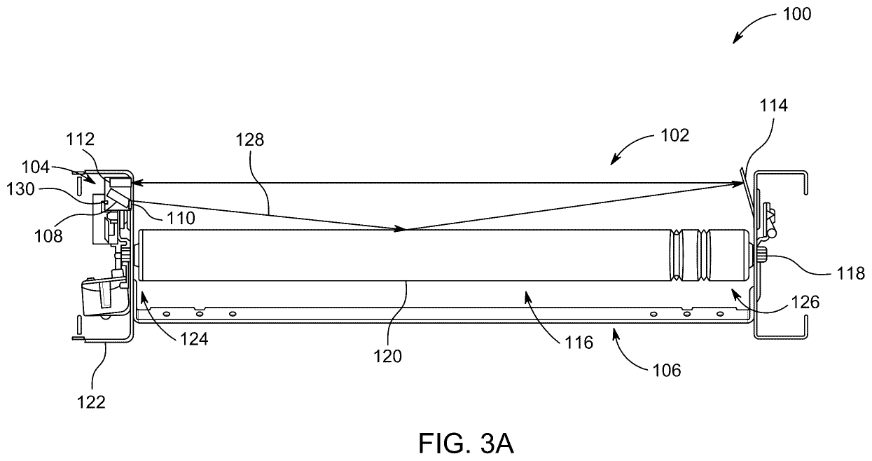

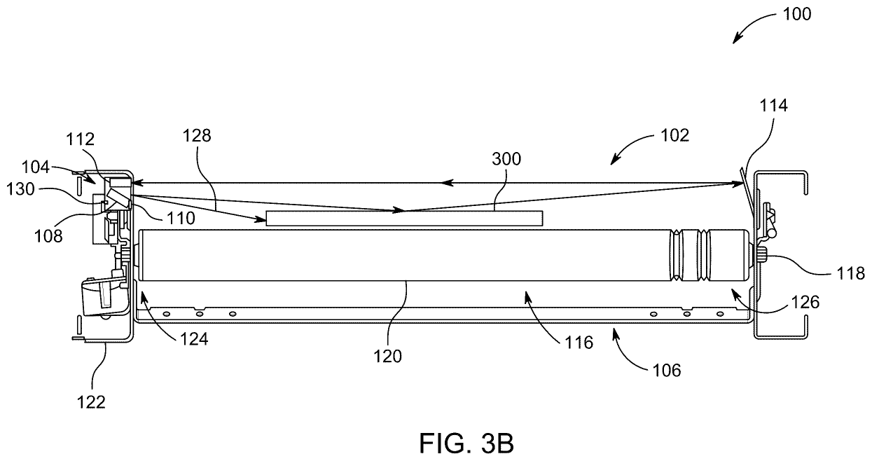

In some embodiments, the object detection system 100 may be coupled with at least one side of the conveyor 102. Further, the conveyor 102 may be configured to transport one or more objects 300 (FIG. 3B) from a source end to a destination end of the conveyor 102. In some embodiments, the one or more objects 300 may correspond to one or more parcels, one or more pouches, one or more boxes, etc. In some embodiments, the conveyor 102 may be installed within a facility (not shown). Further, the facility may correspond to a warehouse, a material loader, etc. In one example, the conveyor 102 may comprise the at least one roller assembly 106. In another example, the conveyor 102 may comprise a conveyor belt (not shown) upstream or downstream from the at least one roller assembly 106. Further, the conveyor belt and/or the at least one roller assembly 106 may be configured to be in a direct contact with the one or more objects 300 that may be transported over the conveyor 102. In some embodiments, the at least one roller assembly 106 may comprise a roller 116 having an axle 118 and an outer shell 120. Further, the outer shell 120 may be constructed in a shape that may correspond to a cylindrical shape. In some embodiments, the outer shell 120 may be composed of a material that may include but not limited to iron, aluminum, steel, etc. In some embodiments, the outer shell 120 may comprise a polished metallic material such as polished stainless steel, polished chrome, or polished aluminum.

In some embodiments, the at least one roller assembly 106 may further comprise a pair of side rails 122. In some embodiments, the pair of side rails 122 may be installed on a first side 124 and a second side 126 of the at least one roller assembly 106 (as illustrated in FIG. 1). In one example, the first side 124 may correspond to a left side of the at least one roller assembly 106 and the second side 126 may correspond to a right side of the at least one roller assembly 106. In some embodiments, the first side 124 and the second side 126 of the at least one roller assembly 106 of the conveyor 102 may be configured to be positioned opposite to each other. Further, the axle 118 of the roller 116 may be configured to enable installation of the roller 116 with the pair of side rails 122. In some embodiments, the pair of side rails 122 may be configured to avoid falling of the one or more objects 300 products from the conveyor 102.

In some embodiments, the at least one sensing unit 104 may be installed at the first side 124 of the at least one roller assembly 106. For example, the at least one sensing unit 104 may be installed on one of the pair of side rails 122. In some embodiments, the at least one sensing unit 104 may comprise the at least one emitter 108. In some embodiments, the at least one emitter 108 may be configured to emit one or more signals 128 in a field of view (FOV) of the at least one emitter 108. In some embodiments, the FOV of the at least one emitter 108 may correspond to a surface of the roller 116 of the at least one roller assembly 106. In some embodiments, the one or more signals 128 may correspond to one or more light rays. In some embodiments, the at least one emitter 108 of the at least one sensing unit 104 may correspond to at least one infrared (IR) emitter. The at least one sensing unit 104 may correspond to a photo eye detector (i.e., a photoelectric sensor) and the at least one emitter 108 may correspond to a light emitter of a photo eye detector. In some embodiments, the at least one emitter 108 may be coupled with a power source. Further, the at least one emitter 108 may be configured to emit the one or more signals 128 upon receiving a predefined voltage from the power source. In some embodiments, the predefined voltage ranges between 5V to 24V.

In one example, when the at least one emitter 108 may correspond to the at least one IR emitter, the at least one IR emitter may be configured to emit the one or more signals 128 (i.e., one or more IR light rays) towards the surface of the roller 116. Further, the at least one IR emitter may comprise an IR source. Further, the IR source may correspond to an IR light emitting diode (LED). Further, the IR source may be configured to generate the one or more IR light rays upon supplied with the predefined voltage. In another example, when the at least one emitter 108 may correspond to the photo eye detector, the photo eye detector may be configured to emit one or more signals 128 (i.e., the one or more light rays). Further, the at least one photo eye emitter may comprise a light source. Further, the light source may correspond to a light emitting diode (LED). Further, the light source may be configured to generate the one or more light rays when supplied with the predefined voltage.

In some embodiments, an angle between the one or more signals 128 emitted by the at least one emitter 108 and a normal to the surface of the roller 116 may define a predefined incident angle I (as illustrated in FIG. 1). Further, the predefined incident angle ranges between 45-90 degrees. In some embodiments, the surface of the roller 116 may be configured to reflect the one or more signals 128 emitted by the at least one emitter 108. In some embodiments, the one or more signals 128 may be configured to reflect from the surface of the roller 116 at a second predefined angle R (as illustrated in FIG. 1). Further, the second predefined angle may correspond to an angle of reflection of 45-90 degrees. It may be noted that angle of incidence may be equal to the angle of reflection as per the law of reflection. In some embodiments, the surface of the roller 116 of the at least one roller assembly 106 may be coated with a material that may include but not limited to aluminum, silver, stainless steel, chrome mirror-grade glass, polymer film, etc. In some embodiments, the material of the surface of the roller 116 may be selected such that the one or more signals 128 may be efficiently reflected without any significant signal loss.

In some embodiments, the at least one sensing unit 104 may further comprise the knob 110. In some embodiments, the knob 110 may be coupled with the at least one emitter 108. In some embodiments, the knob 110 may be configured to rotate the at least one emitter 108 to adjust one or more angles of the one or more signals 128. In some embodiments, the one or more angles may range between 0-90 degrees. In some embodiments, the one or more angles may correspond to an angle of incident of the one or more signals 128 and an angle of reflection of the one or more signals 128. In some embodiments, the knob 110 may define a rotating axis. In some embodiments, the knob 110 may be configured to rotate on the rotating axis to facilitate adjustment of the at least one emitter 108. In some embodiments, the knob 110 may be configured to rotate in a clockwise direction and in an anticlockwise direction. In one example, an external force may be applied on the knob 110 to rotate in the clockwise direction or in the anticlockwise direction. In some embodiments, the knob 110 may be operated automatically based on the size of the object 300 (FIG. 3B).

In some embodiments, the knob 110 may be operationally coupled with the at least one emitter 108 via at least one adjustment mechanism. Further, when the knob 110 moves in the rotating axis, at least one adjustment mechanism may cause the at least one emitter 108 to rotate in one or more planes. In some embodiments, the one or more planes may comprise a vertical plane and a transverse plane. In some embodiments, during the adjustment of the at least one emitter 108 through the knob 110, the one or more signals 128 may also be adjusted in the respective planes. In some embodiments, an angle between the one or more signals 128 reflected by the surface of the roller 116 and the normal to the surface of the roller 116 may define the second predefined angle. Further, the second predefined angle ranges between 45-90 degrees.

In some embodiments, the object detection system 100 may comprise the at least one reflector 114. Further, the at least one reflector 114 may be installed at the second side 126 of the at least one roller assembly 106. Further, the second side 126 of the at least one roller assembly 106 may correspond to a right side of the at least one roller assembly 106. In some embodiments, the at least one reflector 114 may be installed at a predefined angle on the second side 126 of the at least one roller assembly 106. In some embodiments, the predefined angle with respect to the side rail 122 ranges between 0-45 degrees. In some embodiments, the predefined angle with respect the at least one roller assembly 106 ranges between 45-90 degrees. In some embodiments, the at least one reflector 114 may be configured to receive the one or more signals 128 reflected from the surface of the roller 116. In some embodiments, the at least one reflector 114 may be configured to reflect the one or more signals 128 towards the at least one receiver 112. In some embodiments, the at least one reflector 114 may be oriented at the predefined angle that may ensure proper reflection of the one or more signals 128 towards the at least one receiver 112.

In some embodiments, the at least one reflector 114 may be constructed with a shape that may include but not limited to a square shape, a rectangle shape, a circle shape, etc. In some embodiments, the shape of the at least one reflector 114 may be selected such that a presence of noise and/or signal deviation may be prevented. In some embodiments, the at least one reflector 114 may be composed of a material that may include but not limited to aluminum, silver, mirror-grade glass, polymer film, etc. In some embodiments, the material of the at least one reflector 114 may be selected such that the one or more signals 128 may be reflected towards the at least one receiver 112.

In some embodiments, the at least one sensing unit 104 may further comprise the at least one receiver 112. In some embodiments, the at least one receiver 112 may be configured to receive the one or more signals 128 reflected by the at least one reflector 114. In some embodiments, the at least one receiver 112 may correspond to at least one infrared receiver, a photo eye receiver, etc. In one example, when the at least one receiver 112 may correspond to the at least one infrared receiver, the at least one receiver 112 may be configured to receive the one or more signals 128 (i.e., one or more IR rays). In another example, when the at least one receiver 112 may correspond to the photo eye receiver, the at least one receiver 112 may be configured to receive the one or more signals 128 (i.e., one or more light signals).

In some embodiments, the at least one receiver 112 may comprise a photodiode. Further, the photodiode of the at least one receiver 112 may be configured to generate one or more electrical signals corresponding to the one or more signals 128 received from the at least one reflector 114. In some embodiments, the at least one receiver 112 may further comprise an analog-to-digital converter (ADC). Further, the ADC may be configured to convert the one or more electrical signals into one or more digital signals.

In some embodiments, the object detection system 100 may comprise at least one processor (not shown). In some embodiments, the at least one processor may include suitable logic, circuitry, and/or interfaces that are operable to execute one or more instructions stored in a memory to perform predetermined operations. In some embodiments, the at least one processor may be configured to store the one or more fields of the database, the location information, and the determined one or more location coordinates in the memory communicatively coupled to the at least one processor. In one embodiment, the at least one processor may be configured to decode and execute any instructions received from one or more other electronic devices or server(s). The at least one processor may be configured to execute one or more computer-readable program instructions, such as program instructions to carry out any of the functions described in this description. Further, the processor may be implemented using one or more processor technologies known in the art. Examples of the at least one processor includes, but are not limited to, one or more general purpose processors and/or one or more special purpose processors.

In some embodiments, the at least one processor may be configured to receive the one or more digital signals. Further, the at least one processor may be configured to analyze the one or more digital signals received from the at least one receiver 112 using one or more logical algorithms. In one example, the at least one processor may be configured to determine receiving of the one or more signals 128 by the at least one receiver 112 from the at least one reflector 114. In another example, the at least one processor may be configured to determine obstruction of the one or more signals 128 by the one or more object placed over the surface of the roller 116. For example, and as will be discussed further, the at least one processor may determine obstruction of the one or more signals 128 when the one or more signals 128 are not received by the at least one receiver 112 from the at least one reflector 114.

In some embodiments, the object detection system 100 may further comprise a lighting unit 130. Further, the lighting unit 130 may be communicatively coupled with the at least one sensing unit 104 via the at least one processor. In one example, the lighting unit 130 may be configured to be placed within the at least one sensing unit 104. In another example, the lighting unit 130 may be configured to be placed in proximity to the at least one sensing unit 104. In some embodiments, the lighting unit 130 may correspond to a light emitting diode (LED) unit. In some embodiments, the LED unit may be configured to illuminate in a predefined intensity. In some embodiments, the lighting unit 130 may be configured to operate in an ON mode and in an OFF mode.

In one example, the at least one processor may cause the lighting unit 130 to operate in the ON mode upon receiving of the one or more signals 128 by the at least one receiver 112 from the at least one reflector 114. In some embodiments, the LED unit may be configured to illuminate the lights to give a notification regarding the receiving of the one or more signals 128 by the at least one receiver 112. In another example, the at least one processor may cause the lighting unit 130 to operate in the OFF mode upon receiving of the one or more signals 128 by the at least one receiver 112 from the at least one reflector 114.

In some embodiments, the at least one processor may cause the lighting unit 130 to operate in other mode once the one or more signals 128 emitted by the at least one emitter 108 over the surface of the roller 116 may be obstructed by the one or more objects 300 placed over the surface of the roller 116. In one example, the other mode may correspond to a flicker mode. Further. the LED unit may be configured to illuminate a flickering light to notify detection of the one or more objects 300 on the at least one roller assembly 106 of the conveyor 102.

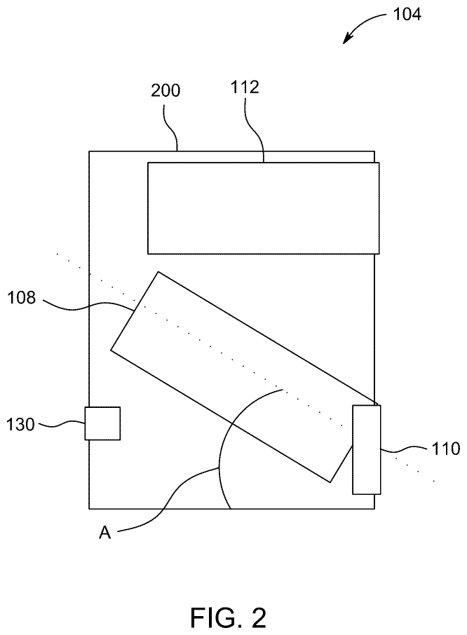

FIG. 2 illustrates a side view of the at least one sensing unit 104 of the object detection system 100, in accordance with an example embodiment of the present disclosure.

In some embodiments, the object detection system 100 may comprise the at least one sensing unit 104. In some embodiments, the at least one sensing unit 104 may be encased inside a housing 200. The housing 200 may be installed at the first side 124 of the at least one roller assembly 106. Further, the housing 200 may be configured to accommodate one or more electrical components, one or more mechanical components, and/or one or more electronic components associated with the object detection system 100. In some embodiments, the housing 200 may be coupled with the first side 124 of the at least one roller assembly 106 though one or more connecting elements. In some embodiments, the housing 200 may be constructed with a shape that may include but not limited to cubic shape, cuboidal shape, spherical shape, etc. Further, the shape of the housing 200 may be selected to maintain compactness of the object detection system 100. In some embodiments, the housing 200 may define one or more dimensions.

In one example, the housing 200 may be coupled with a first side rail from the pair of side rails 122 of the at least one roller assembly 106. In another example, the housing 200 may be coupled with a second side rails from the pair of side rails 122 of the at least one roller assembly 106. In some embodiments, the housing 200 may be composed of a material that may include but not limited to a metal, a polyvinyl chloride (PVC), reinforced alloy, etc. Further, the material of the housing 200 may be selected such the housing 200 may withstand one or more environmental conditions. Further, the one or more environmental conditions may comprise temperature, humidity, mechanical stress generated during operation of the conveyor 102, etc.

In some embodiments, the housing 200 may be configured to accommodate the at least one emitter 108. Further, the at least one emitter 108 may be configured to emit the one or more signals 128 towards the surface of the roller 116. In some embodiments, the knob 110 may be installed within the housing 200. In some embodiments, the housing 200 may be crafted with a groove. Further, a portion of the knob 110 may be exposed from the groove. In some embodiments, the portion of the knob 110 may be crafted with at least one pattern that may be configured to provide grip to the user while applying force on the portion of the knob 110. In some embodiments, the knob 110 may be configured to rotate the at least one emitter 108 to adjust the one or more angles of the one or more signals 128. In some embodiments, the at least one emitter 108 may be adjusted at a predefined angle A (as illustrated in FIG. 2). Further, the predefined angle of the at least one emitter 108 may range between 0-45 degrees. In one example, the housing 200 may be fabricated with a slot. Further, the lighting unit 130 may be positioned within the slot. Further, the lights illuminated by the lighting unit 130 may be configured to pass through the slot to notify the reception of the one or more signals 128 by the at least one receiver 112.

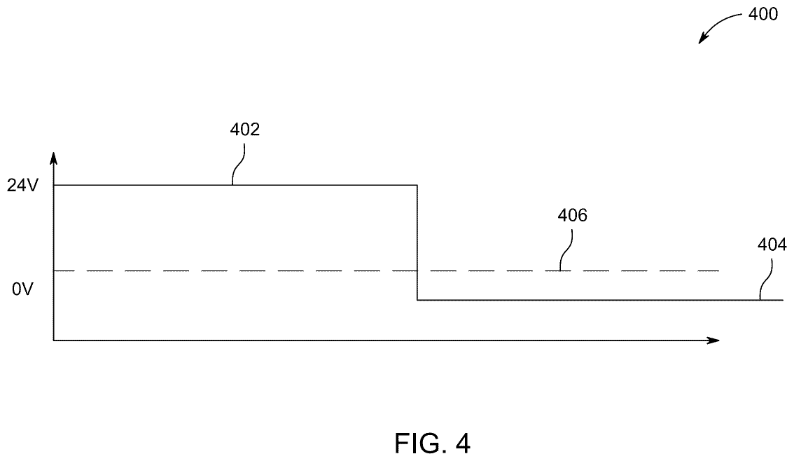

FIG. 3A illustrates a working scenario of the object detection system 100 detecting absence of the one or more objects 300 placed over the conveyor 102, in accordance with an example embodiment of the present disclosure. FIG. 3B illustrates working scenario of the object detection system 100 detecting the one or more objects 300 placed over the conveyor 102, in accordance with an example embodiment of the present disclosure. FIG. 4 illustrates a graphical representation 400 showing the ON mode and the OFF mode of the lighting unit 130, in accordance with an example embodiment of the present disclosure.

In some embodiments, and as depicted in FIG. 3A, when the one or more objects 300 (FIG. 3B) are not be positioned on the roller 116 of the at least one roller assembly 106 of the conveyor 102, the one or more signals 128 emitted by the at least one emitter 108 may be reflected by an outer shell 120 of the roller 116, subsequently reflected by the at least one reflector 114, and subsequently received by the at least one receiver 112. Further, the knob 110 may be rotated by a user in the clockwise direction or in the anticlockwise direction to adjust the one or more angles of the at least one emitter 108. Further, the surface of the roller 116 may be configured to reflect the one or more signals 128. In some embodiments, the one or more signals 128 may be configured to strike over the surface of the roller 116. Further, the one or more signals 128 may be reflected by the surface of the roller 116 towards the at least one reflector 114.

In some embodiments, the at least one reflector 114 may be configured to receive the one or more signals 128 reflected from the surface of the roller 116. Further, the at least one reflector 114 may be configured to reflect the one or more signals 128 towards the at least one receiver 112. In some embodiments, the at least one receiver 112 may be configured to receive the one or more signals 128 reflected by the at least one reflector 114. In some embodiments, the at least one receiver 112 may be communicatively coupled with the lighting unit 130 through the at least one processor. Further, the at least one processor may be configured to receive the one or more digital signals corresponding to the one or more signals 128 received by the at least one receiver 112. Further, the at least one processor may cause the lighting unit 130 to operate in the ON mode upon receiving, by the at least one receiver 112, the one or more signals 128 from the at least one reflector 114. In some embodiments, the ON mode may define a high signal 402 of the graphical representation 400 (as illustrated in FIG. 4). Further, while operating in the ON mode, the lighting unit 130 may be configured to actuate to notify receiving of the one or more signals 128 by the at least one receiver 112.

In some embodiments, and as depicted in FIG. 3B, when the one or more objects 300 (FIG. 3B) are placed over the roller 116 of the at least one roller assembly 106 of the conveyor 102, the at least one emitter 108 may be configured to emit the one or more signals 128 towards the surface of the roller 116, but the one or more signals 128 may be completely or partially obstructed or disrupted by the one or more objects 300. As such, the one or more signals may be scattered by the one or more objects 300 and the strength of the one or more signals 128 reflected from the one or more objects 300, subsequently reflected by the reflector 114, and subsequently received by the receiver 112 may be reduced or eliminated. Further, the one or more signals 128 may be obstructed or disrupted by the one or more objects 300 after striking over the surface of the one or more objects 300. In some embodiments, the at least one reflector 114 may be configured to receive a disrupted form of the one or more signals 128 reflected from the surface of the one or more objects 300. Further, the at least one reflector 114 may be configured to reflect the disrupted one or more signals 128 towards the at least one receiver 112. In some embodiments, the at least one receiver 112 may be configured to receive the disrupted one or more signals 128 reflected by the at least one reflector 114. Further, the at least one processor may be configured to receive the disrupted one or more signals 128 received by the at least one receiver 112.

In some embodiments, the at least one processor may be configured to compare the disrupted one or more signals 128 with a predefined threshold value 406 (as illustrated in FIG. 4). Further, the at least one processor may be configured to determine presence of the one or more objects 300 based at least on the comparison. Further, the at least one processor may cause the lighting unit 130 to operate in an on mode or in an off mode when the one or more signals 128 does not exceed the predefined threshold value 406 and operate in the other of the on mode or the off mode when the one or more signals 128 exceeds the predefined threshold value 406. For example, and with reference to FIG. 4, when the strength of the one or more signals received by the receiver exceeds a predefined threshold value 406, which may correspond to 5 volts, the absence of the one or more objects 300 may be determined by the processor and the lighting unit may be caused to operate in the on mode, and when the strength of the one or more signals received by the receiver is less than or equal to the predefined threshold value 406, the presence of the one or more objects 300 may be determined by the processor and the lighting unit may be caused to operate in the off mode, or vice-versa. In some embodiments, the other mode may define a low signal 404 of the graphical representation 400 (as illustrated in FIG. 4). In one example, when there is absence of the one or more objects 300 over the conveyor 102, the at least one reflector 114 may be configured to receive the one or more signals 128 at an intensity of 5000 counts. In other example, when the one or more objects 300 are placed over the conveyor 102, the at least one reflector 114 may be configured to receive 500 counts.

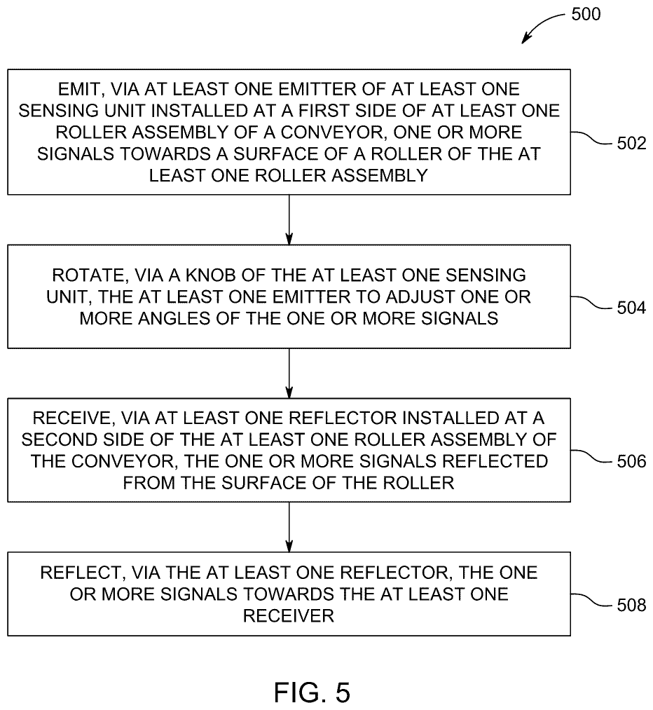

FIG. 5 illustrates a flowchart showing a method 500 of the object detection system 100, in accordance with an example embodiment of the present disclosure.

At operation 502, the at least one emitter 108 of the at least one sensing unit 104 may be configured to emit the one or more signals 128 towards the surface of the roller 116 of at least one roller assembly 106. In some embodiments, the at least one sensing unit 104 may be. installed at the first side 124 of the at least one roller assembly 106 of the conveyor 102. Further, the surface of the roller 116 may be configured to reflect the one or more signals 128 emitted by the at least one emitter 108. In some embodiments, the one or more signals 128 correspond to the one or more light rays.

For example, a conveyor 102 is installed within a warehouse. Further, the conveyor 102 comprises at least one roller assembly 106 having a roller 116. Further, at least one sensing unit 104 is installed at a first side 124 of the at least one roller assembly 106. Further, the at least one sensing unit 104 may further comprise at least one emitter 108. Further, the at least one emitter 108 may be configured to emit one or more signals 128 towards a surface of the roller 116 of the at least one roller assembly 106.

At operation 504, the at least one emitter 108 may be rotated to adjust the one or more angles of the one or more signals 128 by the knob 110 of the at least one sensing unit 104. In some embodiments, the knob 110 may be configured to rotate on the rotating axis. Further, the knob 110 may be configured to rotate the at least one emitter 108 over the rotating axis to adjust the one or more angles of the one or more signals 128. In some embodiments, the knob 110 may be configured to rotate in the clockwise direction and the anticlockwise direction.

For example, the at least one sensing unit 104 further comprises the knob 110. Further, the knob 110 defines a rotating axis. Further, the knob 110 is rotated by a user over the rotating axis to adjust one or more angles of the one or more signals 128. Further, the knob 110 is rotated in a clockwise direction or in an anticlockwise direction. Further, the at least one emitter 108 is configured to move in one or more planes (i.e., X-plane, Y-plane, and Z-plane) to adjust the one or more angles of the one or more signals 128.

At operation 506, the at least one reflector 114 installed at the second side 126 of the at least one roller assembly 106 of the conveyor 102 may be configured to receive the one or more signals 128 reflected from the surface of the roller 116. In some embodiments, the at least one reflector 114 may be installed at the predefined threshold angle to ensure receiving of the one or more signals 128 from the surface of the roller 116. In some embodiments, the surface of the roller 116 may be composed the material that may ensure proper reflection of the one or more signals 128 emitted by the at least one emitter 108 towards the at least one reflector 114.

For example, a second side 126 of the at least one roller assembly 106 is installed with at least one reflector 114. Further, the at least one reflector 114 is configured to receive the one or more signals 128 reflected from a surface of the roller 116. Further, the at least one reflector 114 is installed at a predefined threshold angle to efficiently receive the one or more signals 128 reflected from the surface of the roller 116.

At operation 508, the at least one reflector 114 may be configured to reflect the one or more signals 128 towards the at least one receiver 112. In some embodiments, the at least one reflector 114 may be installed at the predefined threshold angle to ensure proper reflection of the one or more signals 128 towards the at least one receiver 112. Further, the at least one receiver 112 may be communicatively coupled with the lighting unit 130. Further, the lighting unit 130 may be configured to operate in the on mode or the off mode upon receiving, by the at least one receiver 112, the one or more signals 128 from the at least one reflector 114. Further, the lighting unit 130 may be configured to operate in the other of the on mode or the off mode once the one or more signals 128 emitted by the at least one emitter 108 over the surface of the roller 116 may be obstructed by one or more objects 300 placed over the surface of the roller 116.

For example, a second side 126 of the at least one roller assembly 106 may be installed with at least one reflector 114. Further, the at least one reflector 114 reflects the one or more signals 128 towards the at least one receiver 112. Further the at least one receiver 112 causes the lighting unit 130 of the at least one sensing unit 104 to illuminate a light to notify receiving of the one or more signals 128.

For example, the one or more signals 128 emitted by the at least one emitter 108 strikes over a surface of one or more objects 300 placed over the roller 116 of the at least one roller assembly 106. Further, the at least one reflector 114 is configured to receive the one or more signals 128 disrupted from the surface of the one or more objects 300. Further, the at least one reflector 114 reflects the disrupted one or more signals 128 towards the at least one receiver 112. Further the at least one receiver 112 causes the lighting unit 130 of the at least one sensing unit 104 to stop illumination of the light to notify detection of the one or more objects 300 on the roller 116.

Many modifications and other embodiments of the disclosure set forth herein will come to mind to one skilled in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An object detection system for a conveyor, the object detection system comprising:
at least one sensing unit installed at a first side of at least one roller assembly of the conveyor, wherein the at least one sensing unit comprises:
at least one emitter positioned and configured to emit one or more signals towards a surface of a roller of the at least one roller assembly, wherein the surface of the roller is configured to reflect the one or more signals emitted by the at least one emitter;
a knob coupled with the at least one emitter, wherein the knob is configured to rotate the at least one emitter to adjust one or more angles of the one or more signals; and
at least one receiver; and
at least one reflector installed at a second side of the at least one roller assembly of the conveyor, wherein the at least one reflector is configured to receive the one or more signals reflected from the surface of the roller and reflect the one or more signals towards the at least one receiver.

2. The object detection system of claim 1, wherein the at least one sensing unit corresponds to a photo eye detector that is configured to emit the one or more signals over the surface of the roller and receive the one or more signals from the at least one reflector.

3. The object detection system of claim 1, wherein the one or more signals correspond to one or more light rays.

4. The object detection system of claim 1, wherein the knob is configured to rotate the at least one emitter until the at least one receiver receives the one or more signals from the at least one reflector.

5. The object detection system of claim 1, wherein the knob defines a rotating axis, wherein the knob rotates on the rotating axis to facilitate adjustment of the at least one emitter.

6. The object detection system of claim 1, wherein an angle between the one or more signals emitted by the at least one emitter and a normal to the surface of the roller defines a predefined incident angle, wherein the predefined incident angle ranges between 45-90 degrees.

7. The object detection system of claim 6, wherein an angle between the one or more signals reflected by the surface of the roller and the normal to the surface of the roller defines a predefined reflection angle, wherein the predefined reflection angle ranges between 45-90 degrees.

8. The object detection system of claim 1, wherein the first side and the second side of the at least one roller assembly of the conveyor are configured to be positioned opposite to each other and proximate to opposite ends of the roller.

9. The object detection system of claim 1, further comprising a lighting unit communicatively coupled with the at least one sensing unit, wherein the lighting unit is configured to:
operate in an on mode and in an off mode;
operate in the on mode or the off mode upon receiving, by the at least one receiver, the one or more signals from the at least one reflector; and
operate in the other of the on mode or the off mode once the one or more signals emitted by the at least one emitter over the surface of the roller is obstructed by one or more objects placed over the surface of the roller.

10. The object detection system of claim 9, wherein the lighting unit is configured to be placed within the at least one sensing unit or is configured to be placed in proximity to the at least one sensing unit.

11. The object detection system of claim 9, wherein the lighting unit corresponds to a light emitting diode (LED) unit.

12. A method comprising:
emitting, via at least one emitter of at least one sensing unit installed at a first side of at least one roller assembly of a conveyor, one or more signals towards a surface of a roller of the at least one roller assembly, wherein the surface of the roller is configured to reflect the one or more signals emitted by the at least one emitter;
rotating, via a knob of the at least one sensing unit, the at least one emitter to adjust one or more angles of the one or more signals;
receiving, via at least one reflector installed at a second side of the at least one roller assembly of the conveyor, the one or more signals reflected from the surface of the roller; and
reflecting, via the at least one reflector, the one or more signals towards the at least one receiver.

13. The method of claim 12, wherein the at least one sensing unit corresponds to a photo eye detector that is configured to emit the one or more signals over the surface of the roller and receive the one or more signals from the at least one reflector.

14. The method of claim 12, wherein the one or more signals correspond to one or more light rays.

15. The method of claim 12 further comprising rotating, via the knob, the at least one emitter until the at least one receiver receives the one or more signals from the at least one reflector.

16. The method of claim 12, wherein the knob defines a rotating axis, wherein the knob rotates on the rotating axis to facilitate adjustment of the at least one emitter.

17. The method of claim 12, wherein an angle between the one or more signals emitted by the at least one emitter and a normal to the surface of the roller defines a predefined incident angle, wherein the predefined incident angle ranges between 45-90 degrees.

18. The method of claim 17, wherein an angle between the one or more signals reflected by the surface of the roller and the normal to the surface of the roller defines a predefined reflection angle, wherein the predefined reflection angle ranges between 45-90 degrees.

19. The method of claim 12, wherein the first side and the second side of the at least one roller assembly of the conveyor are configured to be positioned opposite to each other and proximate to opposite ends of the roller.

20. The method of claim 12, further comprising:
operating a lighting unit communicatively coupled with the at least one sensing unit, in an on mode and in an off mode,
operating the lighting unit in the on mode or the off mode, upon receiving, by the at least one receiver, the one or more signals from the at least one reflector, and
operating the lighting unit in the other of the on mode or the off mode once the one or more signals emitted by the at least one emitter over the surface of the roller is obstructed by one or more objects placed over the surface of the roller.
